(19) United States
(12) Patent Application Publication
(10) Pub. No.: US 2021/0362734 A1
(43) Pub. Date: Nov. 25, 2021

(54) DATA FUSION METHOD AND APPARATUS FOR VEHICLE SENSOR

(71) Applicant: GREAT WALL MOTOR COMPANY LIMITED, Hebei (CN)

(72) Inventors: Jianyong GE, Hebei (CN); Tianpei WANG, Hebei (CN); Kai ZHANG, Hebei (CN); Hongwei LIU, Hebei (CN); Hongliang LIU, Hebei (CN); Yaxing REN, Hebei (CN); Lin HE, Hebei (CN); Xiaochuan LI, Hebei (CN)

(21) Appl. No.: 17/281,557

(22) PCT Filed: Sep. 27, 2019
(86) PCT No.: PCT/CN2019/108400

§ 371 Date: Mar. 30, 2021

(30) Foreign Application Priority Data
Sep. 30, 2018 (CN) 201811154323.0

(51) Int. Cl. B60W 50/02; G06F 16/245

(52) U.S. Cl. CPC B60W 50/0225; G01S 13/865; G06F 16/245; B60W 50/0205

(57) ABSTRACT

Disclosed are a data fusion method and apparatus for a vehicle sensor, the method comprising: reading a parameter attribute set of each target detected by a sensor arranged on a vehicle, wherein the parameter attribute set at least comprises one or more of the following: longitudinal velocity, longitudinal distance and transverse distance; generating an attribute combination according to the read parameter attribute set of each target detected by each sensor; and determining an overlap ratio of the parameter attribute set in each attribute combination, and carrying out data fusion based on the overlap ratio so as to obtain a first data fusion list, wherein the first data fusion list comprises the overlap ratio of each attribute combination and the parameter attribute set corresponding to the overlap ratio of each attribute combination. The method simplifies determination logic of a subsequent decision-making system and improves security and operating efficiency of the whole system.

### FIELD OF THE INVENTION

The present invention relates to the field of data fusion, and in particular, to a data fusion method and device for vehicle sensors.

### BACKGROUND OF THE INVENTION

Due to performance deficiencies, a single sensor cannot achieve target detection for obstacles in to some situations, for example, a camera cannot detect targets under poor lighting conditions. Therefore, an autonomous vehicle needs a variety of sensors to detect targets in order to achieve all-round perception of the surrounding environment.

If target data detected by a plurality of sensors is output directly, a huge amount of data is transmitted, and the following problems will be caused: a target is falsely detected, for example, there is no obstacle but an obstacle is output; missed detection of a target occurs, for example, there is an obstacle but no obstacle is output; attributes of a same target are inconsistent; and optimal attributes of a target cannot be acquired, etc. These problems will cause great inconvenience in the judgment logic of a decision-making system, and reduce the safety and operating efficiency of the entire system.

### SUMMARY OF THE INVENTION

In view of this, an objective of the present invention is to propose a data fusion method for vehicle sensors to at least solve the technical problem of a huge amount of data transmitted caused by direct output of target data detected by a plurality of sensors.

To achieve the above objective, a technical solution of the present invention is implemented as follows.

A data fusion method for vehicle sensors includes: reading parameter attribute set of each target detected by sensors arranged on a vehicle, the parameter attribute set at least including one or more of: a longitudinal speed, a longitudinal distance, and a lateral distance; generating an attribute Nj combination according to the read parameter attribute set of each target detected by each of the sensors, wherein each attribute combination includes a parameter attribute set of one target selected from the parameter attribute sets of one or more targets detected by each of the sensors; and determining a coincidence degree of the parameter attribute sets in each attribute combination, and performing data fusion based on the coincidence degree to obtain a first data fusion list, wherein the first data fusion list includes the coincidence degree of each attribute combination and one or more parameter attribute sets corresponding to the coincidence degree of each attribute combination, wherein the coincidence degree refers to the number of the parameter attribute sets corresponding to a same target in the attribute combination.

Further, determining the coincidence degree of the parameter attribute sets in each attribute combination comprises executing the following steps for each attribute combination: calculating a discrete degree of n parameter attributes in each same type in n parameter attribute sets in the attribute combination respectively, determining whether the discrete degree of the n parameter attributes in each same type is within a corresponding predetermined range; if the discrete degree of to n parameter attributes in each same type is within the corresponding predetermined range, determining the coincidence degree of the parameter attribute sets in the attribute combination to be n: and if the discrete degree of the n parameter attributes in each same type is not within the corresponding predetermined range, determining the coincidence degree of the parameter attribute sets in the attribute combination to be 1, wherein n is a positive integer, and a value of n is greater than or equal to 2 and less than or equal to the number of parameter attribute sets of targets in the attribute combination.

Further, the determined coincidence degree of the parameter attribute sets in the attribute combination has a plurality of values, a largest value in the plurality of values is selected as the coincidence degree of the parameter attribute sets in the attribute combination.

Further, determining the coincidence degree of the parameter attribute sets in each attribute combination comprises: for each attribute combination, successively decreasing the value of n starting from the largest value of n, until the coincidence degree of the parameter attribute sets in the attribute combination is determined.

Further, the predetermined range is determined by the following steps: selecting a predetermined range corresponding to a parameter attribute detected by a specific sensor among the n parameter attributes from a pre-stored predetermined range list, wherein the predetermined range list may include a range of the parameter attribute detected by the specific sensor and a predetermined range corresponding to the range of each parameter attribute detected by the specific sensor.

Further, the discrete degree is a standard deviation, variance, or average deviation.

Further, the method further comprising: deleting repeatedly fused data in the first data fusion list to obtain a second data fusion list.

Further, the parameter attribute set further comprise target ID, and the method comprises deleting the repeatedly fused data by the following steps: determining whether a target ID set corresponding to a coincidence degree p is included in a target ID set corresponding to a coincidence degree q, wherein a value of q is greater than a value of p; and if the target ID set corresponding to the coincidence degree p is included in the target ID set corresponding to the coincidence degree q, deleting data corresponding to the coincidence degree p from the first data fusion list, wherein p and q are both positive integers, the value of p is greater than or equal to 1 and less than the largest value of the coincidence degree, and the value of q is greater than 1 and less than or equal to the largest value of the coincidence degree.

Further, generating the attribute combinations according to the read parameter attribute set of each target detected by each of the sensors comprises: adding a parameter attribute set of an empty target to the parameter attribute sets of the one or more targets detected by each sensor respectively; and generating the attribute combinations based on the parameter attribute sets added with the parameter attribute set of the empty target.

Compared with the prior art, the data fusion method for the vehicle sensors of the present invention has the following advantages:

in the data fusion method for the vehicle sensors of the present invention, the parameter attribute sets of each target detected by the sensors are combined, and a coincidence degree of the parameter attribute sets in each attribute combination is determined, and then data fusion is performed based on the coincidence degree to obtain a first data fusion list. In the first data fusion list, the parameter attribute sets for the same target are fused, so that a decision-making system conveniently uses the data fusion list subsequently, the judgment logic of the decision-making system is simplified, and the safety and operating efficiency of the entire system are improved.

Another objective of the present invention is to propose a data fusion device for vehicle sensors to at least solve the technical problem of a huge amount of data transmitted caused by direct output of target data detected by a plurality of sensors.

To achieve the above objective, a technical solution of the present invention is implemented as follows.

A data fusion device for vehicle sensors includes a memory and a processor, wherein the memory stores instructions which are configured to enable the processor to execute the above-mentioned data fusion method for the vehicle sensors.

The data fusion device for the vehicle sensors has the same advantages as the above-mentioned data fusion method for vehicle sensors over the prior art, which will not be described in detail herein.

Other features and advantages of embodiments of the present invention will be described in detail in the subsequent section of detailed description of the embodiments.

### BRIEF DESCRIPTION OF DRAWINGS

The accompanying drawings are intended to provide further understanding of the embodiments of the present invention and form part of the specification, and are used, together with the following specific implementations, for explaining the embodiments of the present invention, but do not limit the embodiments of the present invention. In the drawings:

FIG. 1 shows a flow diagram of a data fusion method for vehicle sensors according to an embodiment of the present invention;

FIG. 2 shows a schematic diagram of a process of determining a coincidence degree of parameter attribute sets in an attribute combination according to an embodiment of the present invention; and

FIG. 3 shows a structural block diagram of a data fusion device for vehicle sensors according to an to embodiment of the present invention.

### BRIEF DESCRIPTION OF THE SYMBOLS

310 Memory 320 Processor

### DETAILED DESCRIPTION OF THE EMBODIMENTS

Specific implementations of the embodiments of the present invention will be described in detail below in conjunction with the accompanying drawings. It should be understood that the specific implementations described herein are only used for illustrating and explaining the embodiments of the present invention, instead of limiting the embodiments of the present invention.

A “sensor” mentioned in the embodiments of the present invention may be any type of device arranged on a vehicle for detecting a target, for example, may be a camera, lidar, millimeter-wave radar or the like. A “target” mentioned in the embodiments of the present invention may be any moving or stationary object in front of, behind or at a lateral side of a vehicle, such as an automobile, a human, or a building.

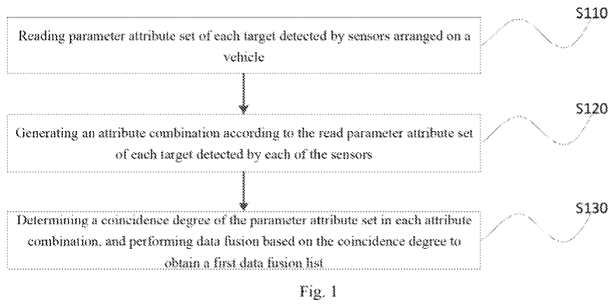

FIG. 1 shows a flow diagram of a data fusion method for vehicle sensors according to an embodiment of the present invention. As shown in FIG. 1, an embodiment of the present invention provides a data fusion method for vehicle sensors. The method may be set to be executed in real time or set to be executed once every predetermined time. The method may include steps S110 to S130.

In step S110, parameter attribute set of each target detected by sensors arranged on a vehicle are read. Herein, it is possible to read a parameter attribute set of each target detected by each of a plurality of sensors selected in advance, or read a parameter attribute set of each target detected by each of all sensors, wherein the sensors may be of a same type or different types.

A sensor may detect one or more targets, and for each target, the sensor may determine a parameter attribute set of each target. The parameter attribute set includes multiple types of parameter attributes, such as parameter attributes related to speed, distance, and the like. The parameter attribute set read in the step S110 may include one or more of: a longitudinal speed, a longitudinal distance, and a lateral distance. In the embodiment of the present invention, the longitudinal speed may a speed of the detected target along a traveling direction of the vehicle; the longitudinal distance may be a longitudinal distance of the detected target relative to the vehicle; and the lateral distance may be a lateral distance of the detected target relative to the vehicle, wherein the longitudinal speed, the longitudinal distance and the lateral distance may be determined in a vehicle coordinate system. It may be understood that the parameter attribute set of the target may include other parameter attributes, such as a lateral speed, a longitudinal accelerated speed of the target, a lateral accelerated speed of the target, a length of the target, and/or a width of the target.

It may be understood that in the step S110, the read parameter attribute sets detected by the sensors are parameter attribute sets detected by the sensors at approximately the same time.

In step S120, an attribute combination is generated according to the read parameter attribute set of each target detected by each of the sensors.

Each generated attribute combination may include a parameter attribute set of one target selected respectively from the one or more targets detected by each sensor. That is, the attribute combination includes the same number of parameter attribute set as the sensors, and the included parameter attribute sets are detected by different sensors respectively. In actual execution, the parameter attribute sets of one target detected by one sensor may be successively acquired respectively to generate the attribute combination. It may be understood that the number of the generated attribute combinations may be a product of the numbers of the targets detected by each sensor.

As a simple example, suppose there are three sensors, which are denoted as A, B, and C, respectively. A sensor A detects two targets, and obtains parameter attribute sets of the two targets, respectively, denoted as A1 and A2. A sensor B detects three targets, and obtains parameter attribute sets of the three targets, respectively, denoted as B1, B2, and B3. A sensor C detects one target, and obtains a parameter attribute set of the one target, denoted as C1. The parameter attribute sets of the targets detected by the sensors A, B. and C are read, and 6 attribute combinations may be generated according to the read parameter attribute sets of the targets. The 6 attribute combinations are, for example: {A1, B1, C1}, {A1, B2, C1}, {A1, B3, C1}, {A2, B1, C1}, {A2, B2, C1}, and {A2, B3, C1}, respectively.

In step S130, a coincidence degree of the parameter attribute sets in each attribute combination is determined, and data fusion is performed based on the coincidence degree to obtain a first data fusion list.

The first data fusion list may include the coincidence degree of each attribute combination and the parameter attribute sets corresponding to the coincidence degree of each attribute combination.

In the embodiment of the present invention, the coincidence degree refers to the number of parameter attribute sets corresponding to a same target in the attribute combination. As a simple example, if parameter attribute sets A1 and B1 in an attribute combination including parameter attribute sets A1. B1, and C1 correspond to a same target, it may be determined that a coincidence degree of this attribute combination is 2. The obtained first data fusion list may include the coincidence degree value of 2 and the parameter attribute sets A1 and B1 corresponding to the coincidence degree value of 2.

A plurality of coincidence degrees may also be determined for one attribute combination, and the plurality of coincidence degrees and parameter attribute sets corresponding to each of the plurality of coincidence degrees may be included in the first data fusion list.

The first data fusion list is generated and output by fusing parameter attribute sets corresponding to the same target, so that a decision-making system more conveniently uses the parameter attributes of the target subsequently, thereby simplifying the judgment logic of the decision-making system.

In some embodiments, a sensor may detect no target, and accordingly may not output a parameter attribute set of a target, which means that a parameter attribute set of a target cannot be read from this sensor. To facilitate subsequent calculation of the coincidence degree, when an attribute combination is generated according to the read parameter attribute set of each target detected by each sensor, a parameter attribute set of an empty target may be added first for each sensor, which is equivalent to virtualizing a detection target for each sensor. For example, if a sensor actually detects 10 targets and obtains parameter attribute set of each of the 10 targets, after a parameter attribute set of an empty target is added, the sensor corresponds to the parameter attribute sets of the 11 targets. After the parameter attribute set of the empty target is added, an attribute combination may be generated by using the parameter attribute set(s) after the addition. It may be understood that among the generated attribute combinations, there will be an attribute combination that includes parameter attribute sets of all empty targets. This attribute combination is a void attribute combination that has no practical meaning, and the void attribute combination may be deleted during actual operation.

Assuming that 5 sensors are arranged on a front side of a vehicle, the numbers of targets detected by the 5 sensors are N1, N2, N3, N4, and N5, respectively, the numbers of parameter attribute sets read correspondingly from the 5 sensors are N1, N2, N3, N4, and N5. A parameter attribute set of an empty target is added for each sensor, and the numbers of parameter attribute sets corresponding to the 5 sensors become N1+1, N2+1, N3+1, N4+1, and N5+1. To generate attribute combinations, a parameter attribute set of one target corresponding to each sensor may be successively acquired. The number of generated attribute combinations is a product of N1+1, N2+1, N3+1, N4+1, and N5+1, and after a void attribute combination is deleted, the number of the remaining attribute combinations is the product of N1+1, N2+1, N3+1, N4+1, and N5+1, minus 1. Herein, N1, N2, N3, N4, and N5 are all integers greater than or equal to 0.

By adding the parameter attribute set of the empty target, it can ensure that the number of parameter attribute sets in an attribute combination is the same as the number of the corresponding sensors, which simplifies the complexity of subsequent calculation of a coincidence degree and improves the efficiency of program operation.

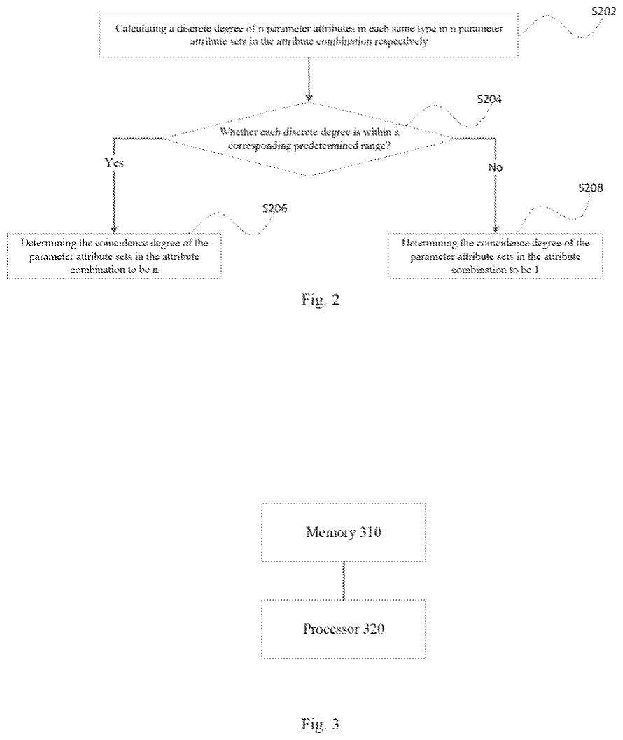

FIG. 2 shows a schematic diagram of a process of determining a coincidence degree of parameter attribute sets in an attribute combination according to an embodiment of the present invention. As shown in FIG. 2, based on any of the above embodiments, steps S202 to S208 may be executed to determine the coincidence degree for each attribute combination.

In step S202, a discrete degree of n parameter attributes of each same type in n parameter attribute sets in an attribute combination is calculated.

In the embodiment of the present invention, the discrete degree may be a standard deviation, variance, average deviation, or the like, preferably a standard deviation, but the embodiment of the present invention is not limited thereto, and any data that can represent the discrete degree may be used. In the embodiment of the present invention, n is a positive integer, and a value of n is greater than or equal to 2 and less than or equal to the number of parameter attribute sets of targets in the attribute combination.

Specifically, a discrete degree may be calculated for any n parameter attribute sets in the attribute combination, that is, a discrete degree may be calculated for n parameter attributes indicating a longitudinal speed, a discrete degree may be calculated for n parameter attributes indicating a lateral distance, or a discrete degree may be calculated for n parameter attributes indicating a longitudinal distance.

In step S204, it is determined whether the discrete degree of n parameter attributes in each same type is within a corresponding predetermined range.

Predetermined ranges corresponding to different types of parameter attributes may be fixed values. Alternatively, the predetermined ranges corresponding to different types of parameter attributes may be different, and/or for parameter attributes in a same type, if value ranges of the parameter attributes are different, the corresponding predetermined ranges may also be different.

Optionally, a predetermined range list may be pre-stored, and may include ranges of parameter attributes detected by a specific sensor and a predetermined range corresponding to the range of each parameter attribute detected by the specific sensor. In other words, predetermined ranges are determined based on ranges of parameter attributes detected by a specific sensor. Specific sensors selected for different types of parameter attributes may be different. Optionally, a sensor with higher accuracy may be used as a specific sensor. For example, for the longitudinal distance, a lidar may be used as a specific sensor, and detects different longitudinal distance ranges which correspondingly store different predetermined ranges. When the step S204 is executed, a predetermined range corresponding to a parameter attribute detected by a specific sensor among the n parameter attributes may be selected from the pre-stored predetermined range list, and then judgment may be made based on the predetermined range.

If it is determined in the step S204 that the discrete degree of n parameter attributes in each same type is within the corresponding predetermined range, step S206 is executed. If it is determined in step S204 that the discrete degree of n parameter attributes in each same type is not within the corresponding predetermined range, step S208 is executed.

In step S206, it may be determined that the coincidence degree of the parameter attribute sets in the attribute combination is n, that is, the n parameter attribute sets correspond to a same detection target, and the n parameter attribute sets may be fused. Optionally, the determined coincidence degree may have a plurality of values, and a largest value of the plurality of values may be selected as the coincidence degree of the parameter attribute sets in the attribute combination. Optionally, there may be a plurality of largest values in the determined coincidence degree. In this case, each of the plurality of largest values and parameter attribute sets corresponding thereto may all be included in the first data fusion list.

In step S208, it may be determined that the coincidence degree of the parameter attribute sets in the attribute combination is 1, that is, the n parameter attribute sets respectively correspond to different detection targets, and the n parameter attribute sets cannot be fused. In this case, each parameter attribute set of the it parameter attribute sets and the coincidence degree thereof may be all included in the first data fusion list.

Optionally, for each attribute combination, the coincidence degree may be determined by successively decreasing the value of n starting from the largest value of n, until the coincidence degree of the parameter attribute sets in the attribute combination is determined.

5 sensors are taken as an example for illustration, the numbers of parameter attribute sets corresponding to the 5 sensors are E1, E2, E3, E4, and E5 respectively. Attribute combinations are generated according to the parameter attribute sets corresponding to the 5 sensors, and the number of the generated attribute combinations is denoted as F. In the embodiment of the present invention, E1, E2, E3, E4, E5, and F are all positive numbers. A value of F is a product of E1. E2, E3, E4, and E5, or the value of F is a product of E1, E2, E3, E4, and E5 minus 1. Each attribute combination has 5 parameter attribute sets, and the 5 attribute sets correspond to different sensors respectively. Herein. the value of n is 2 to 5.

In calculation of a coincidence degree of parameter attribute sets in each attribute combination, the largest value 5 is first selected to be n for each attribute combination, that is, 5 parameter attribute sets in the attribute combination are used first to determine the coincidence degree. If a discrete degree of 5 parameter attributes of each type of parameter attributes in the 5 parameter attribute sets is within a corresponding predetermined range, that is, a discrete degree of 5 longitudinal speeds is within a corresponding first predetermined range, a discrete degree of 5 longitudinal distances is within a corresponding second predetermined range, and a discrete degree of 5 lateral distances is within a corresponding third predetermined range, the coincidence degree of the parameter attribute sets in the attribute combination may be determined to be 5. If the discrete degree of 5 parameter attributes of each type of parameter attributes in the 5 parameter attribute sets is not within the corresponding predetermined range, any 4 parameter attribute sets in the attribute combination are used to determine the coincidence degree. In any 4 parameter attribute sets, if a discrete degree of 4 parameter attributes of each type of parameter attributes in the 4 parameter attribute sets is within a corresponding predetermined range, the coincidence degree of the parameter attribute sets in the attribute combination may be determined to be 4. If any 4 parameter attribute sets do not meet the condition that ‘a discrete degree of 4 parameter attributes of each type of parameter attributes in the 4 parameter attribute sets is within a corresponding predetermined range’, any 3 parameter attribute sets in the attribute combination are used to determine the coincidence degree. In any 3 parameter attribute sets, if a discrete degree of 3 parameter attributes of each type of parameter attributes in the 3 parameter attribute sets is within a corresponding predetermined range, the coincidence degree of the parameter attribute sets in the attribute combination may be determined to be 3. If any 3 parameter attribute sets do not meet the condition that ‘a discrete degree of 3 parameter attributes of each type of parameter attributes in the 3 parameter attribute sets is within a corresponding predetermined range’, any 2 parameter attribute sets in the attribute combination are used to determine the coincidence degree. In any 2 parameter attribute sets, if a discrete degree of 2 parameter attributes of each type of parameter attributes in the 2 parameter attribute sets is within a corresponding predetermined range, the coincidence degree of the parameter attribute sets in the attribute combination may be determined to be 2. If any 2 parameter attribute sets do not meet the condition that ‘a discrete degree of 2 parameter attributes of each type of parameter attributes in the 2 parameter attribute sets is within a corresponding predetermined range’, the coincidence degree of the parameter attribute sets may be determined to be 1.

After the coincidence degree is determined, data fusion may be performed so that the first data fusion list includes each coincidence degree of each attribute combination and parameter attribute set(s) corresponding to each coincidence degree. In the obtained first data fusion list, there may be some repeatedly fused data, which means that some parameter attribute sets may be stored multiple times for a same target. If the first data fusion list are directly output to a subsequent decision-making stage, false targets may be generated.

Further, based on any of the above-mentioned embodiments, the data fusion method for the vehicle sensors provided in the embodiment of the present invention may further include deleting repeatedly fused data from the first data fusion list to obtain a second data fusion list.

The parameter attribute set in the embodiment of the present invention may also include target ID. In the first data fusion list, it may be determined whether a target ID set corresponding to any single coincidence degree p is included in a target ID set corresponding to any single coincidence degree q, wherein p and q are both positive integers, a value of p is greater than or equal to 1 and less than the largest value of the coincidence degree, and a value of q is greater than 1 and less than or equal to the largest value of the coincidence degree, wherein the value of q is greater than the value of p. If the target ID set corresponding to the single coincidence degree p is included in the target ID set corresponding to the single coincidence degree q, it indicates that a parameter attribute set corresponding to the coincidence degree p is repeatedly fused data and may be deleted, otherwise parameter attribute set corresponding to the coincidence degree p may be not deleted. For example, if the first data fusion list has the following target ID sets: a target ID set ID1/ID2/ID3/ID4/ID5 corresponding to a coincidence degree 5; a target ID set ID1-ID2/ID3/ID4 corresponding to a coincidence degree 4; a target ID set ID1/ID2 corresponding to a coincidence degree 2, it may be determined that these target ID sets correspond to a same target, and a parameter attribute set corresponding to the target ID set ID1/ID2/ID3/ID4 and a parameter attribute set corresponding to the target ID set ID1/ID2 may be deleted from the first data fusion list.

A second data fusion list may be obtained by deleting all repeatedly fused data in the first data fusion list according to the target ID. It can be understood that the repeatedly fused data may be determined by not only target ID, and may also be determined by determining whether the parameter attribute set corresponding to the single coincidence degree p is included in the parameter attribute set corresponding to the single coincidence degree q. If the parameter attribute set corresponding to the single coincidence degree p is included in the parameter attribute set corresponding to the single coincidence degree q, it may be determined that the parameter attribute set corresponding to the single coincidence degree p is repeatedly fused data and may be deleted.

The simplified second data fusion list is obtained by deleting the repeatedly fused data in the first data fusion list, so that false targets are not generated when the second data fusion list is used in the subsequent decision-making stage, and the accuracy of a decision-making operation in the subsequent decision-making stage is improved.

Correspondingly, an embodiment of the present invention further provides a machine-readable storage medium that stores instructions which are configured to enable a machine to execute the data fusion method for the vehicle sensors according to any embodiment of the present invention. The machine-readable medium may include any one or more of: any entity or device capable of carrying computer program codes, a recording medium, a USB flash disk, a mobile hard disk, a magnetic disk, an optical disk, a computer memory, a read-only memory (ROM), a random access memory (RAM), an electric carrier signal, a telecommunication signal and a software distribution medium, etc.

FIG. 3 shows a structural block diagram of a data fusion device for vehicle sensors according to an embodiment of the present invention. As shown in FIG. 3, the embodiment of the present invention further provides a data fusion device for the vehicle sensors. The device may include a memory 310 and a processor 320. The memory 310 may store instructions which enable the processor 320 to execute the data fusion method for the vehicle sensors according to any embodiment of the present invention.

The processor 320 may be a central processing unit (CPU), and may also be other general-purpose processor, a digital signal processor (DSP), an application specific integrated circuit (ASIC), a field-programmable gate array (FPGA) or other progranunable logic devices, a discrete gate or a transistor logic device, a discrete hardware component or the like.

The memory 310 may be configured to store the computer program instructions, and the processor implements various functions of the data fusion device for the vehicle sensors by running or executing the computer program instructions stored in the memory and calling data stored in the memory. The memory 310 may include a high-speed random access memory, and may also include a non-volatile memory, such as a hard disk, an internal memory, a plug-in hard disk, a smart media card (SMC), a secure digital (SD) card, a flash card, at least one magnetic disk storage device, a flash memory device, or other volatile solid-state storage devices.

Specific working principles and benefits of the data fusion device for the vehicle sensors provided in the embodiment of the present invention are similar to specific working principles and benefits of the data fusion method for the vehicle sensors provided in the above embodiment of the present invention, and will not be described in detail herein.

Optional implementations of the embodiments of the present invention are described above in detail in conjunction with the accompanying drawings. However, the embodiments of the present invention are not limited to the specific details in the above implementations. Within the scope of the technical concept of the embodiments of the present invention, various simple modifications may be made to the technical solutions of the embodiments of the present invention, and these simple modifications are all encompassed within the protection scope of the embodiments of the present invention.

In addition, it should be noted that the specific technical features described in the above-mentioned specific implementations may be combined in any suitable manner without contradiction. To avoid unnecessary repetition, various possible combinations will not be described separately in the embodiments of the present invention.

Those skilled in the art may understand that all or part of the steps in the method of the above-mentioned embodiments may be implemented by relevant hardware instructed by a program, and the program is stored in a storage medium, and includes a number of instructions configured to enable a single-chip microcomputer chip or processor to execute all or part of the steps in the method of the embodiments of the present application. The aforementioned storage medium includes: a USB flash disk, a mobile hard disk, an ROM, an RAM, a magnetic disk, an optical disk or other various media that can store program codes.

In addition, various different implementations of the embodiments of the present invention may also be combined optionally, and the combinations should also be regarded as contents disclosed in the embodiments of the present invention so long as they do not depart from the idea of the present invention.

1. A data fusion method for vehicle sensors, comprising:
reading parameter attribute set of each target detected by sensors arranged on a vehicle, the parameter attribute set at least comprising one or more of: a longitudinal speed, a longitudinal distance, and a lateral distance;
generating an attribute combination according to the read parameter attribute set of each target detected by each of the sensors, each attribute combination comprising a parameter attribute set of one target selected respectively from parameter attribute sets of one or more targets detected by the sensors; and
determining a coincidence degree of the parameter attribute sets in each attribute combination, and performing data fusion based on the coincidence degree to obtain a first data fusion list, wherein the first data fusion list comprises a coincidence degree of each attribute combination and one or more parameter attribute sets corresponding to the coincidence degree of each attribute combination, and the coincidence degree refers to a number of parameter attribute sets corresponding to a same target in the attribute combination.

2. The method according to claim 1, wherein determining the coincidence degree of the parameter attribute sets in each attribute combination comprises executing the following steps for each attribute combination:
calculating a discrete degree of n parameter attributes in each same type in n parameter attribute sets in the attribute combination respectively;
determining whether the discrete degree of the n parameter attributes in each same type is within a corresponding predetermined range;
if the discrete degree of n parameter attributes in each same type is within the corresponding predetermined range, determining the coincidence degree of the parameter attribute sets in the attribute combination to be n; and
if the discrete degree of the n parameter attributes in each same type is not within the corresponding predetermined range, determining the coincidence degree of the parameter attribute sets in the attribute combination to be 1,
wherein n is a positive integer, and a value of n is greater than or equal to 2 and less than or equal to the number of parameter attribute sets of targets in the attribute combination.

3. The method according to claim 2, wherein if the determined coincidence degree of the parameter attribute sets in the attribute combination has a plurality of values, a largest value in the plurality of values is selected as the coincidence degree of the parameter attribute sets in the attribute combination.

4. The method according to claim 2, wherein determining the coincidence degree of the parameter attribute sets in each attribute combination comprises:
for each attribute combination, successively decreasing the value of n starting from the largest value of n, until the coincidence degree of the parameter attribute sets in the attribute combination is determined.

5. The method according to claim 2, wherein the predetermined range is determined by the following steps:
selecting a predetermined range corresponding to a parameter attribute detected by a specific sensor among the n parameter attributes from a pre-stored predetermined range list, wherein the predetermined range list may include a range of the parameter attribute detected by the specific sensor and a predetermined range corresponding to the range of each parameter attribute detected by the specific sensor.

6. The method according to claim 2, wherein the discrete degree is a standard deviation, variance, or average deviation.

7. The method according to claim 1, further comprising:
deleting repeatedly fused data in the first data fusion list to obtain a second data fusion list.

8. The method according to claim 7, wherein the parameter attribute set further comprise target ID, and the method comprises deleting the repeatedly fused data by the following steps:
determining whether a target ID set corresponding to a coincidence degree p is included in a target ID set corresponding to a coincidence degree q, wherein a value of q is greater than a value of p; and
if the target ID set corresponding to the coincidence degree p is included in the target ID set corresponding to the coincidence degree q, deleting data corresponding to the coincidence degree p from the first data fusion list,
wherein p and q are both positive integers, the value of p is greater than or equal to 1 and less than the largest value of the coincidence degree, and the value of q is greater than 1 and less than or equal to the largest value of the coincidence degree.

9. The method according to claim 1, wherein generating the attribute combinations according to the read parameter attribute set of each target detected by each of the sensors comprises:
adding a parameter attribute set of an empty target to the parameter attribute sets of the one or more targets detected by each sensor respectively; and
generating the attribute combinations based on the parameter attribute sets added with the parameter attribute set of the empty target.

10. A data fusion device for vehicle sensors, comprising a memory and a processor, wherein the memory stores instructions which are configured to enable the processor to execute the following steps:
reading parameter attribute set of each target detected by sensors arranged on a vehicle, the parameter attribute set at least comprising one or more of a longitudinal speed, a longitudinal distance, and a lateral distance;
generating an attribute combination according to the read parameter attribute set of each target detected by each of the sensors, each attribute combination comprising a parameter attribute set of one target selected respectively from parameter attribute sets of one or more targets detected by the sensors; and
determining a coincidence degree of the parameter attribute sets in each attribute combination, and performing data fusion based on the coincidence degree to obtain a first data fusion list, wherein the first data fusion list comprises a coincidence degree of each attribute combination and one or more parameter attribute sets corresponding to the coincidence degree of each attribute combination, and the coincidence degree refers to a number of parameter attribute sets corresponding to a same target in the attribute combination.

11. The method according to claim 2, further comprising:
deleting repeatedly fused data in the first data fusion list to obtain a second data fusion list.

12. The data fusion device for vehicle sensors according to claim 10, wherein determining the coincidence degree of the parameter attribute sets in each attribute combination comprises executing the following steps for each attribute combination:
calculating a discrete degree of n parameter attributes in each same type in n parameter attribute sets in the attribute combination respectively;
determining whether the discrete degree of the n parameter attributes in each same type is within a corresponding predetermined range;
if the discrete degree of n parameter attributes in each same type is within the corresponding predetermined range, determining the coincidence degree of the parameter attribute sets in the attribute combination to be n; and
if the discrete degree of the n parameter attributes in each same type is not within the corresponding predetermined range, determining the coincidence degree of the parameter attribute sets in the attribute combination to be 1,
wherein n is a positive integer, and a value of n is greater than or equal to 2 and less than or equal to the number of parameter attribute sets of targets in the attribute combination.

13. The data fusion device for vehicle sensors according to claim 12, wherein if the determined coincidence degree of the parameter attribute sets in the attribute combination has a plurality of values, a largest value in the plurality of values is selected as the coincidence degree of the parameter attribute sets in the attribute combination.

14. The data fusion device for vehicle sensors according to claim 12, wherein determining the coincidence degree of the parameter attribute sets in each attribute combination comprises:
for each attribute combination, successively decreasing the value of n starting from the largest value of n, until the coincidence degree of the parameter attribute sets in the attribute combination is determined.

15. The data fusion device for vehicle sensors according to claim 12, wherein the predetermined range is determined by the following steps:
selecting a predetermined range corresponding to a parameter attribute detected by a specific sensor among the n parameter attributes from a pre-stored predetermined range list, wherein the predetermined range list may include a range of the parameter attribute detected by the specific sensor and a predetermined range corresponding to the range of each parameter attribute detected by the specific sensor.

16. The data fusion device for vehicle sensors according to claim 12, wherein the discrete degree is a standard deviation, variance, or average deviation.

17. The data fusion device for vehicle sensors according to claim 10, the instructions further configured to enable the processor to execute the following step:
deleting repeatedly fused data in the first data fusion list to obtain a second data fusion list.

18. The data fusion device for vehicle sensors according to claim 17, the parameter attribute set further comprise target ID, the instructions further configured to enable the processor to execute the following step to delete the repeatedly fused data:
determining whether a target ID set corresponding to a coincidence degree p is included in a target ID set corresponding to a coincidence degree q, wherein a value of q is greater than a value of p; and
if the target ID set corresponding to the coincidence degree p is included in the target ID set corresponding to the coincidence degree q, deleting data corresponding to the coincidence degree p from the first data fusion list,
wherein p and q are both positive integers, the value of p is greater than or equal to 1 and less than the largest value of the coincidence degree, and the value of q is greater than 1 and less than or equal to the largest value of the coincidence degree.

19. The data fusion device for vehicle sensors according to claim 10, wherein generating the attribute combinations according to the read parameter attribute set of each target detected by each of the sensors comprises:
adding a parameter attribute set of an empty target to the parameter attribute sets of the one or more targets detected by each sensor respectively; and
generating the attribute combinations based on the parameter attribute sets added with the parameter attribute set of the empty target.

20. A machine-readable storage medium, storing instructions which are configured to enable a machine to execute the data fusion method for the vehicle sensors of claim 1.
